(19) United States
(12) Patent Application Publication
(10) Pub. No.: US 2024/0310861 A1
(43) Pub. Date: Sep. 19, 2024

(54) METHOD, APPARATUS AND SYSTEM FOR AUTOMATICALLY ADJUSTING OPENING DEGREE OF FLUID CONTROL VALVE

(71) Applicant: Chengdu University of Technology, Chengdu, SC (US)

(72) Inventors: Jianguo ZHAO, Chengdu (CN); Penghui LIANG, Chengdu (CN); Qingyou LIU, Chengdu (CN); Guorong WANG, Chengdu (CN); Haotian ZHENG, Chengdu (CN); Hanxiu PENG, Chengdu (CN); Min WAN, Chengdu (CN); Gang HU, Chengdu (CN); Xu LUO, Chengdu (CN); Yingju PEI, Chengdu (CN); Xingming WANG, Chengdu (CN); Xianwei DAI, Chengdu (CN); Xuanhe TANG, Chengdu (CN); Lei TAO, Chengdu (CN)

(21) Appl. No.: 18/418,172

(22) Filed: Jan. 19, 2024

(30) Foreign Application Priority Data
Mar. 16, 2023 (CN) 202310251497.3
May 18, 2023 (CN) 202310564022.X

(51) Int. Cl. G05D 7/06; G05B 13/04

(52) U.S. Cl. CPC G05D 7/0623; G05B 13/041; G05D 7/0635

(57) ABSTRACT

A method, an apparatus and a system for automatically adjusting an opening degree of a fluid control valve, relating to the technical field of oil and gas exploration and development. The method includes: establishing a fluid control valve having an orifice structure in oil and gas production; using a numerical simulation method to obtain the influence law of minimum opening degree adjustment step on oil and gas production; obtaining relevant production test data of the oil and gas well, and calculating the total oil and gas production and the oil and gas production of each production layer based on the production test data of the oil and gas well; dividing the production layer segments into high, middle and low-production layers according to the production ratio of each production layer segment; respectively calculating the average productions of the high, middle and low-production layers.

### CROSS-REFERENCE TO RELATED APPLICATIONS

This application claims priority of Chinese Patent Application No. 202310564022.X, filed on May 18, 2023 and application Ser. No. 202310251497.3, filed on Mar. 16, 2023, the entire contents of which are incorporated herein by reference.

### TECHNICAL FIELD

The present disclosure relates to the technical field of oil and natural gas exploration and development, and in particular, to a method, an apparatus and a system for automatically adjusting an opening degree of a fluid control valve.

### BACKGROUND

Oil and natural gas are currently the main resources for industrial production in China and are essential for supporting its development. By 2021, the global reserves of oil are 236.23 billion tons, and the global reserves of natural gas are 205.3 trillion cubic meters. However, due to geological reasons, the global distribution of oil is extremely uneven. With the development of society and the continuous improvement of people's living standards, more oil and natural gas are needed to support national development. By 2021, China's dependence on foreign oil exceeds 73%, and natural gas climbs to 46%, greatly exceeding the internationally recognized warning line. And at the same time, affected by the political instability of oil and natural gas exporting countries and the rapid growth in the worldwide consumption of oil and natural gas resources, the phenomenon of short supply of oil and natural gas resources often occurs in China, which threatens its energy security to a certain extent.

The situation of oil and natural gas resources in the formation is very complicated. Due to the stratigraphic structure, the distribution of oil and natural gas in the formation is very uneven. And due to the complex energy relationship between the layers, i.e., physical differences, fluid seepage velocity, oil, gas and water dynamics distribution, non-uniformity of injection and extraction, and the existence of fracture-fault-hyperpertonic zones, etc., the mutual interference of the flowing layers would inevitable be caused. As a result, when production factors unfavorable to the well occur in one or more layers, the production of oil and gas wells will be affected, and even production will be stopped. Therefore, how to balance the exploitation of oil and gas has become an urgent problem to be solved. In this context, the technical solution disclosed in the Chinese Patent No. CN216342059U realizes the control of balanced production by reasonably distributing the individual liquid production volume of each oil layer and the reference flow rate of each flow control filter, which is difficult to implement, and the controlled flow filter is prone to wear. The technical solution disclosed in the Chinese Patent No. CN203925433U realizes the purpose of changing the seepage state and pressure distribution in the thermal recovery process of the horizontal segment to achieve balanced oil recovery, but its implementation tool structure is complex and requires the use of heat-resistant materials, which has certain limitations.

Therefore, in order to automatically adjust the opening degree of throttle orifice of fluid control valves in actual working conditions to achieve the purpose of balanced recovery, there is an urgent need for a method for automatically adjusting the opening degree of the fluid control valve. In the process of oil and gas field development, the complex interlayer energy relations of the formation, such as physical differences, fluid seepage rate, dynamic distribution of oil, gas and water, non-uniformity of injection and extraction, and the existence of fractures-faults-hypertonic zones, etc., will inevitably lead to the mutual interference of the flowing layers. As a result, when production factors unfavorable to the well occur in one or more layers, the production of oil and gas wells will be affected, and even production will be stopped. Therefore, conventional completion techniques have been difficult to meet the requirements of production. In order to accurately control the balanced exploitation of each layer and study the influence of various complex factors in the formation, it is particularly critical to accurately control the value of the balanced exploitation of each layer.

The technical solution disclosed in Chinese Patent Application Publication No. CN114151046A realizes the control of balanced production by reasonably distributing the individual fluid production volume of each oil layer and the reference flow rate of each flow control filter, which is troublesome to implement and difficult to accurately control the exploitation rate of the oil layer. The technical solution disclosed in the Chinese Patent No. CN204941480U uses friction to impede and reduce the liquid, so as to control the pressure drop to achieve balanced production, which is difficult to implement, and the casing is prone to wear and tear leading to failure. The above two patents have not carried out any numerical simulation, and have failed to study the influence of stratigraphic factors on the equalization of exploitation in each layer.

### SUMMARY

In order to improve the described problem, the present disclosure provides a method, device and system for automatically adjusting the opening degree of a fluid control valve.

The present disclosure provides method for automatically adjusting an opening degree of a fluid control valve, applying to fluid control valves each with an orifice structure in oil and gas production, including:
performing simulation based on an opening degree Change of orifices of each of the fluid control valves with different step sizes, obtaining an influence law of an opening degree adjustment step size of a single-layer fluid control valve on oil and gas production, and an influence law of a minimum opening degree adjustment step size on oil and gas production;
testing oil and gas via a layering system, so as to obtain production test data of an oil and gas well equipped with the fluid control valves;
evaluating production capacity of each of production layers of the oil and gas well based on the production test data, so as to obtain a total production of the oil and gas well and a production of each of the production layers, and numbering each of the production layers in sequence;
calculating a percentage of the production of each of the production layers to the total production, and dividing the production layers into high-production layers, middle-production layers and low-production layers based on the percentage of the production of each of the production layers to the total production; calculating average productions of the high-production layers, the middle-production layers and the low-production layers respectively;
calculating an opening degree of the orifices of each of the fluid control valves by dichotomy when productions of the production layers are balanced based on above calculation results.

Optionally, the performing simulation based on the opening degree Change of orifices of each of the fluid control valves with different step sizes specifically includes:
fixing a pressure difference of each of the fluid control valves;
dividing the fluid control valves into multiple groups respectively corresponding to different adjustment accuracies, based on the opening degree Change of the orifices of each of the fluid control valves with different step sizes, and numerically simulating a flow field of the fluid control valves of each of the multiple groups

Optionally, the performing simulation specifically includes:
S1, adopting a numerical simulation method to change the opening degree of the orifices of each of the fluid control valves and an inlet pressure and fixing an outlet pressure, so as to simulate a production change of the single-layer fluid control valve under different pressure difference parameters; and evaluating a throttling performance of the fluid control valves of each of the high-production layers and low-production layers, so as to provide a basis for actual production engineering;
S2, simulating a flow field of a multi-layer fluid control valve, and simulating a pressure drop of a horizontal segment of the multi-layer fluid control valve by using a horizontal segment orifice;
S3, establishing a numerical simulation model of the multi-layer fluid control valve based on an area of the horizontal segment orifice calculated in S2, setting natural gas and crude oil as a fluid medium;
S4, adjusting a valve spacing, the pressure difference and the opening degree based on the numerical simulation method, analyzing a mutual influence law between opening degrees of the production layers, an influence law of formation pressure on the opening degree in different layer segments and an influence law of different valve spacings on the opening degree;
S5, based on results obtained in S4, programming a relationship between the opening degree, the valve spacing and the pressure difference when natural gas production is balanced, obtaining a size of the opening degree of the orifices during balanced production by inputting different valve spacings and pressure differences, so as to provide reference and theoretical support for actual production engineering.

Optionally, the calculating the opening degree of the orifices of each of the fluid control valves by dichotomy when productions of the production layers are balanced includes:
adjusting and calculating the high-production layers, the middle-production layers and the low-production layers respectively, adjusting the opening degree of each of layer segments from full opening of 100%, and reducing the opening degree by half in turn, that is, adjusting the production of each of the production layers by the opening degree of 100%, 50%, 25%, 12.5% and 6.25% in sequence, until a difference between the percentage of the production of each of the production layers to the total production and the percentage of average production to the total production is less than the minimum error of balanced production;
obtaining an adjusted production and a proportion of each of the production layers by real-time simulation after adjusting the opening degree by dichotomy, and further adjusting production layers which fail to meet requirement by dichotomy;
a calculation formula of the dichotomy is:

$$\vert \frac{f ( {x}_{i} )}{F ( {x}_{k} )} - \overline{\frac{f ( {x}_{k} )}{F ( {x}_{k} )}} \vert \leq Δ x , i = 1 , 2 , 3 … n$$

where xₖ indicates different types of production layer segments, and the value of k corresponds to high, middle and low-production layers; xᵢ indicates an i-th production layer, and a value of i is 1, 2, 3 . . . n; F(xₖ) indicates the total oil and gas production of different types of production layers; F(xᵢ) indicates an oil and gas production of the i-th production layer; f̅(̅x̅ₖ̅)̅ indicates an average oil and gas production of the types of production layer segments; Δx indicates the minimum error of balanced production

Optionally, before adopting the numerical simulation method to change the opening degree of the orifices of each of the fluid control valve, based on a structure and working principle of the fluid control valves, establishing and simplifying the numerical simulation model of the single-layer fluid control valve by combining with actual working conditions of the fluid control valves in different production layers under an intelligent well; selecting crude oil and natural gas as a fluid material to obtain a fluid flow state and fluid rheological parameters.

Optionally, the calculating the opening degree of the orifices of each of the fluid control valves by dichotomy when productions of the production layers are balanced further includes:
calculating the production layers with a difference of production percentage exceeding the minimum error of balanced production each time;
reducing an opening degree of a corresponding production layer when a production of the corresponding production layer is greater than the average production of the production layers; increasing an opening degree of the corresponding production layer when the production of the corresponding production layer is less than the average production of the production layers

Optionally, the method further includes maintaining an opening degree of a production layer, the production of the production layer being less than the average production and opening degree being of 100%; and adjusting a production layer with a difference of a production percentage exceeding the minimum error of balanced production.

Optionally, the fluid rheological parameters includes viscosity, density, specific heat capacity, thermal conductivity, and thermal expansion coefficient of 0 to 100%.

Optionally, the method further includes: for multiple production layers with a same production and opening degree, and a difference of a production percentage exceeding the minimum error of balanced production, numbering the multiple production layers in sequence, and adjusting the opening degree through a formula:

$${T}_{N} = \frac{{T}_{0}}{{2}^{N}} , N = 1 , 2 , 3 , 4$$

where T_{N} indicates an opening degree of an orifice of a fluid control valve in different layers, and T_{N}≥6.25%; N indicates a layer segment number; T₀ indicates an opening degree of a fluid control valve in a current layer, and T₀≥6.25%; when a value of N is greater than 4, T₀ is 6.25%.

Optionally, when simulating the production change of the single-layer fluid control valve under different pressure difference parameters in S1, setting the opening degree of the orifices of each of the fluid control valves within the range of 0-100%, fixing the outlet pressure, changing the inlet pressure, and controlling a pressure difference change to obtain a crude oil and natural gas production under different pressure differences.

Optionally, when simulating the pressure drop of the horizontal segment of the multi-layer fluid control valve by using a horizontal segment orifice in S2, obtaining a fluid flow regime, calculating a friction coefficient of each segment of a horizontal well, carrying out a pressure drop of horizontal well segment based on Fanning friction formula, and calculating an orifice area of the horizontal well segment; Fanning friction coefficient calculation formula, Fanning friction formula and formula of orifice area of the horizontal well segment are:

$$f = \frac{a}{R {e}^{b}}$$

$$Δ p = \frac{2 f ρ {v}^{2} L}{d}$$

$$A = \frac{q}{{C}_{q} \sqrt{Δ p \frac{2}{ρ}}}$$

where L indicates a pipe length, m; d indicates a pipe diameter, m; p indicates density of working fluid, kg/m³, v indicates an average flow rate of working fluid, m/s; f indicates Fanning friction coefficient, dimensionless; and Re indicates Reynolds number, dimensionless, when fluid state is turbulent, n=1; Cq indicates flow coefficient, dimensionless, and circular hole flow coefficient is 0.82.

Optionally, when analyzing the mutual influence law between the opening degrees of production layers in S4, arranging the fluid control valves of each of the production layers with a constant valve spacing, keeping the inlet and outlet pressures constant, and changing an orifice opening degree of each of the production layers, so as to obtain change results of natural gas production of each of the production layers.

Optionally, when analyzing the influence law of different valve spacings on the opening degree in S4, arranging the fluid control valves of each of the production layers with different valve spacings, keeping the outlet pressure and the inlet pressure constant, and adjusting the orifice opening degree of each of the production layers, so as to obtain change results of natural gas production of each of the production layers.

Optionally, when analyzing the influence law of formation pressure on the opening degree in different layer segments in S4, arranging the fluid control valves of each of production layers with a constant valve spacing, keeping the outlet pressure constant, changing the inlet pressure of different layers, and adjusting the orifice opening degree of each of the production layers, so as to obtain change results of natural gas production of each of the production layers.

Optionally, the obtaining an influence law of an opening degree adjustment step size of a single-layer fluid control valve on oil and gas production, and an influence law of a minimum opening degree adjustment step size on oil and gas production includes:
calculating a law result of a production change of each of the production layers and opening degree adjusting step sizes of the fluid control valves in simulation data of each of the groups;
selecting an opening degree adjustment accuracy which causes a smallest production change of each of the production layers and determining the opening degree adjustment accuracy as a minimum opening degree adjustment step size;
setting a production change corresponding to the minimum opening degree adjustment step size as a minimum error of balanced production.

Optionally, the calculating the opening degree of the orifices of each of the fluid control valves by dichotomy when productions of the production layers are balanced includes:
adjusting and calculating the high-production layers, the middle-production layers and the low-production layers respectively, adjusting the opening degree of each of layer segments from full opening of 100%, and reducing the opening degree by half in turn, that is, adjusting the production of each of the production layers by the opening degree of 100%, 50%, 25%, 12.5% and 6.25% in sequence, until a difference between the percentage of the production of each of the production layers to the total production and the percentage of average production to the total production is less than the minimum error of balanced production;
obtaining an adjusted production and a proportion of each of the production layers by real-time simulation after adjusting the opening degree by dichotomy, and further adjusting production layers which fail to meet requirement by dichotomy;
a calculation formula of the dichotomy is:

$$\vert \frac{f ( {x}_{i} )}{F ( {x}_{k} )} - \overline{\frac{f ( {x}_{k} )}{F ( {x}_{k} )}} \vert \leq Δ x , i = 1 , 2 , 3 … n$$

where, xₖ indicates different types of production layer segments, and the value of k corresponds to high, middle and low-production layers; xᵢ indicates an i-th production layer, and a value of i is 1, 2, 3 . . . n; F(xₖ) indicates the total oil and gas production of different types of production layers; F(xᵢ) indicates an oil and gas production of the i-th production layer; f̅(̅x̅ₖ̅)̅ indicates an average oil and gas production of the types of production layer segments; Δx indicates the minimum error of balanced production.

Optionally, the calculating the opening degree of the orifices of each of the fluid control valves by dichotomy when productions of the production layers are balanced further includes:
calculating the production layers with a difference of production percentage exceeding the minimum error of balanced production each time;
reducing an opening degree of a corresponding production layer when a production of the corresponding production layer is greater than the average production of the production layers; increasing an opening degree of the corresponding production layer when the production of the corresponding production layer is less than the average production of the production layers.

Optionally, the method further includes maintaining an opening degree of a production layer, the production of the production layer being less than the average production and opening degree being of 100%; and adjusting a production layer with a difference of a production percentage exceeding the minimum error of balanced production.

Optionally, the method further includes for multiple production layers with a same production and opening degree, and a difference of a production percentage exceeding the minimum error of balanced production, numbering the multiple production layers in sequence, and adjusting the opening degree through a formula:

$${T}_{N} = \frac{{T}_{0}}{{2}^{N}} , N = 1 , 2 , 3 , 4$$

where T_{N} indicates an opening degree of an orifice of a fluid control valve in different layers, and T_{N}≥6.25%; N indicates a layer segment number; T₀ indicates an opening degree of a fluid control valve in a current layer, and T₀≥6.25%; when a value of N is greater than 4, T₀ is 6.25%.

Optionally, the production test data of the oil and gas well includes a formation pressure, a bottom hole flowing pressure, a test production, and formation parameters.

The present disclosure further provides an apparatus for automatically adjusting an opening degree of a fluid control valve, applying to fluid control valves each with an orifice structure in oil and gas production, including:
a simulation unit used for performing simulation based on an opening degree Change of orifices of each of the fluid control valves with different step sizes, obtaining an influence law of an opening degree adjustment step size of a single-layer fluid control valve on oil and gas production, and obtaining an influence law of a minimum opening degree adjustment step size on oil and gas production;
a data acquisition unit used for obtain production test data of an oil and gas well equipped with fluid control valves through testing oil and gas via a layering system;
a production capacity evaluation unit used for evaluating production capacity of each of the production layers of the oil and gas well based on the production test data, obtaining a total production of the oil and gas well and a productions of each of the production layers, and numbering each of the production layers in sequence;
a production calculation unit used for calculating a percentage of the production of each of the production layers to the total production, dividing the production layers into high-production layers, middle-production layers, and low-production layers based on the percentage of production of each of the production layers to the total production, calculating average productions of the high-production layers, middle-production layers, and low-production layers respectively;
an opening degree Calculation unit used for calculating an opening degree of orifices of each of the fluid control valves by dichotomy when productions of the production layers are balanced based on above calculation results.

The present disclosure further provides a system for automatically adjusting an opening degree of a fluid control valve, including:
one or more fluid control valves, each of the fluid control valves has an orifice structure in oil and gas production;
a fluid control valve control module for controlling an opening degree of each of the fluid control valves.

The fluid control valve control module includes one or more processors, a memory, and one or more application programs; the one or more application programs are stored in the memory and configured to be executed by the one or more processors, and the one or more application programs are configured to execute the method mentioned above.

Compared with the prior art, the present disclosure has the following advantages.

First, the embodiments of the present disclosure are theoretically reliable, has a simple calculation method, includes a set of entire calculation flow for automatically adjusting the opening degree of the fluid control valves, and is applicable to a variety of fluid control valves having a throttling orifice structure.

Second, different adjustment accuracy is simulated based on the opening degree Change of the orifices of the fluid control valve with different step sizes, the influence law of minimum opening degree adjustment step on oil and gas production is obtained. This method can be applied to various fluid control valves and is simple and effective, the minimum opening degree of the orifice and minimum error in balanced production caused by fluid control valves for oil and gas production changes can be quickly obtained.

Third, the binary method is adopted to automatically adjust the opening degree of the fluid control valve to adapt to different production layers, thereby achieving the goal of balanced production. This method can be applied to various types of oil and gas wells, the reliability and feasibility of setting the opening degree of orifice of the fluid control valve are increased, and provides a reference and thought for an actual production process.

### BRIEF DESCRIPTION OF THE DRAWINGS

In order to describe the technical solutions in the embodiments of the present disclosure more clearly, the drawings needed in the embodiments will be briefly introduced below. It is understood that the following drawings illustrate only some embodiments of the present disclosure and therefore should not to be considered as limiting of the scope of the present disclosure. For a person of ordinary skill in the art, other drawings may also be obtained according to these drawings without creative efforts.

FIG. 1 is a method flow chart of a method for automatically adjusting an opening degree of a fluid control valve according to an embodiment of the present disclosure;

FIGS. 2A to 2D show simulation result diagrams of simulating and emulating four groups according to the embodiment of the present disclosure respectively;

FIG. 3 is a flowchart of algorithm steps of a simulation according to the present disclosure;

FIGS. 4A and 4B respectively show a front view and a rear view of a schematic diagram of a numerical simulation model of a single-layer fluid control valve;

FIG. 5 is a schematic diagram of boundary conditions of the single-layer fluid control valve;

FIGS. 6A to 6D show crude oil and natural gas production curves of the single layer fluid control valve in high and low production layers;

FIGS. 7A and 7B respectively show a front view and a rear view of a schematic diagrams of a numerical simulation model of a multi-layer fluid control valve;

FIG. 8 is a schematic diagram of boundary conditions of the multi-layer fluid control valve;

FIGS. 9A to 9D show production cloud charts of layers with opening degree variation respectively;

FIGS. 10A to 10D show production cloud charts of formation pressure difference and opening degree;

FIGS. 11A to 11D show production cloud charts of valve spacing and opening degree;

FIG. 12 is a change curve between layer segment and opening degree during balanced production;

FIG. 13 is a change curve between formation pressure difference and opening degree during balanced production;

FIG. 14 is a change curve between valve spacing and opening during balanced production;

FIG. 15 is a schematic diagram of a production and proportion of each production layer of an oil and gas well according to the embodiment of the present disclosure;

FIG. 16 is a schematic logic diagram of the method for automatically adjusting the opening degree of the fluid control valve according to the embodiment of the present disclosure;

FIG. 17 is a schematic diagram of a production of each production layer and its proportion to a total production after adjusting an opening degree of the 14th layer by dichotomy once according to the embodiment of the disclosure;

FIG. 18 is a schematic diagram of a ratio of a production of each production layer in high-production layer segment to a total production of the high-production layer segment after adjusting the opening degree of the 14th layer by dichotomy once;

FIG. 19 is a schematic diagram of a production of each production layer and its proportion to a total production after adjusting the opening degrees of the 12th, 5th and 3rd layers by dichotomy once respectively according to the embodiment of the present disclosure;

FIG. 20 is a schematic diagram of a ratio of a production of each production layer to a total production of the middle-production layer segment after the opening degrees of the 12th, 5th and 3rd layers by dichotomy respectively according to the embodiment of the present disclosure;

FIG. 21 is a schematic diagram of a production of each production layer of the middle-production layer segment and a proportion of the production to a total production after dichotomies on the 14th layers three times and dichotomy on the 13th layers once according to the embodiment of the present disclosure;

FIG. 22 is a schematic diagram of a ratio of a production of each production layer of the high-production layer segment to a total production of the high-production layer segment after dichotomies on the 14 layers three times and dichotomy on the 13 layers once according to the embodiment of the present disclosure;

FIG. 23 is a schematic diagram of numbering the low-production layers after both the high-production layers and middle-production layers reach balanced production in the embodiment of the present disclosure; and

FIG. 24 is a functional block diagram of an apparatus for automatically adjust an opening degree of a fluid control valve according to the embodiment of the present disclosure.

List of reference signs: 1 orifice; 2 flow channel of outer cylinder of fluid control valve; 3 flow channel of inner cylinder of fluid control valve; 4 one side closure; 5 flow direction of fluid; 6 orifice of horizontal segment; 10 fluid control valve of primary layer; 20 fluid control valve of other layer; 110 simulation unit; 120 data acquisition unit; 130 production capacity evaluation unit; 140 production calculation unit; 150 opening degree Calculation unit.

### DETAILED DESCRIPTION OF THE EMBODIMENTS

The situation of oil and natural gas resources in the formation is very complicated. Due to the stratigraphic structure, the distribution of oil and natural gas in the formation is very uneven. And due to the complex energy relationship between the layers, i.e., physical differences, fluid seepage velocity, oil, gas and water dynamics distribution, non-uniformity of injection and extraction, and the existence of fracture-fault-hyperpertonic zones, etc., the mutual interference of the flowing layers would inevitable be caused. As a result, when production factors unfavorable to the well occur in one or more layers, the production of oil and gas wells will be affected, and even production will be stopped. Therefore, how to balance the exploitation of oil and gas has become an urgent problem to be solved. In order to automatically adjust the opening degree of orifices of fluid control valves in actual working conditions to achieve the purpose of balanced recovery, there is an urgent need for a method for automatically adjusting the opening degree of the fluid control valve.

In view of this, a designer of the present disclosure designs a method, an apparatus and a system for automatically adjusting an opening degree of a fluid control valve, which can be applied to various types of oil and gas wells, increases the reliability and feasibility of setting the opening degree of orifices of the fluid control valve, and provides a reference and thought for an actual production process.

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. The components of embodiments of the present disclosure generally described and illustrated in the drawings herein may be arranged and designed in a variety of different configurations.

Therefore, the following detailed description of the embodiments of the disclosure, as provided in the drawings, is not intended to limit the protection scope of present disclosure, but represents only the selected embodiments of the present disclosure. All other embodiments obtained by a person of ordinary skill in the art based on the embodiments of the present disclosure without creative efforts shall fall within the protection scope of the present disclosure

It should be noted that similar numerals and letters represent similar items in the following figures, and thus, once an item is defined in a figure, it need not be further defined and explained in subsequent figures.

It should be noted that the embodiments of the present disclosure and the features in the embodiments can be combined with each other without conflict.

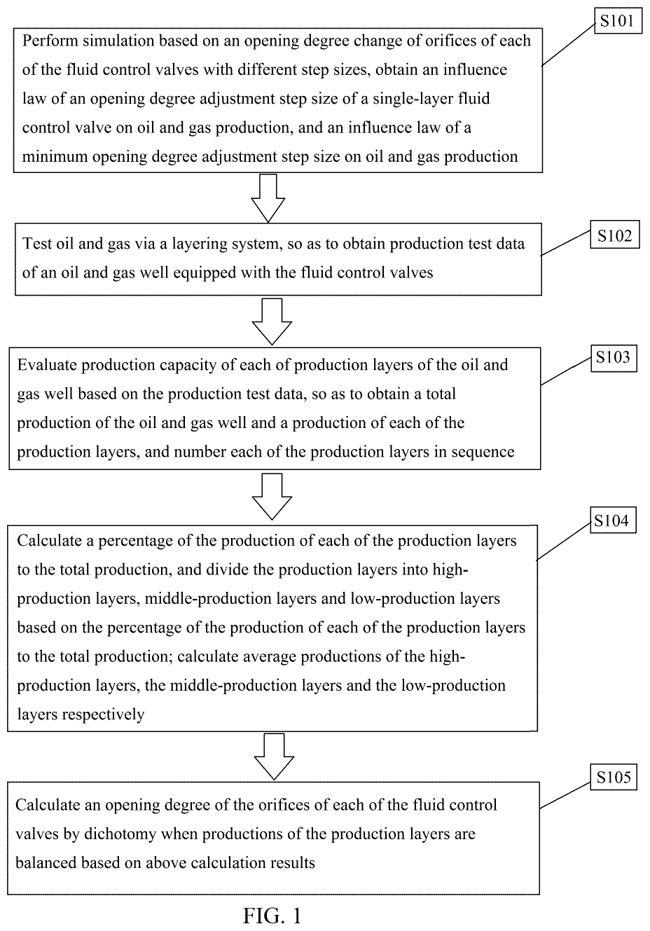

As shown in FIG. 1, a method for automatically adjusting an opening degree of a fluid control valve provided by the embodiment of the present disclosure, which is applied to the fluid control valve having an orifice structure in oil and gas production, includes the following steps.

Step S101, simulation is performed based on an opening degree Change of the orifices of each fluid control valve with different step sizes, an influence law of an opening degree adjustment step size of a single-layer fluid control valve on oil and gas production, and an influence law of a minimum opening degree adjustment step size on oil and gas production are obtained.

Firstly, according to the formation environmental conditions and the working principle of the fluid control valve, the simulation model of the fluid control valve with an orifice structure in oil and gas production is established, and then the simulation is carried out on the basis of this model.

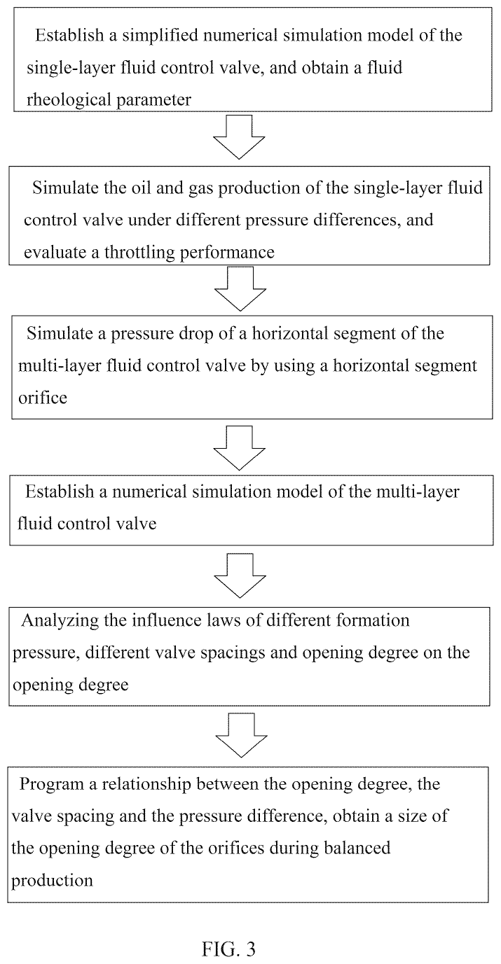

As shown in FIG. 3, a method for calculating the precise opening degree of the fluid control valve based on numerical simulation includes the following steps.

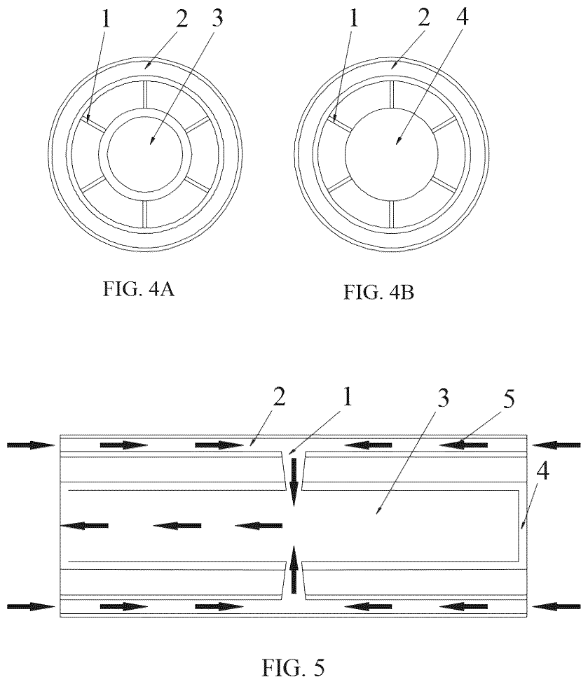

S1: based on the structure and working principle of the fluid control valve, combined with the actual working conditions of the fluid control valve in different production layers under the intelligent well, the numerical simulation model of the single-layer fluid control valve is established and simplified. As shown in FIGS. 4A and 4B, a numerical simulation model of a single-layer fluid control valve includes an orifice 1, a flow channel 2 of outer cylinder of fluid control valve, a flow channel 3 of inner cylinder of fluid control valve and an one side closure 4, and the fluid enters from the flow channel of the outer cylinder of the fluid control valve and flows out from the flow channel of the inner cylinder of the fluid control valve through the throttles bores. Crude oil and natural gas are selected as the fluid materials to obtain the fluid flow state and the rheological parameters of the fluid, including viscosity, density, specific heat capacity, thermal conductivity and thermal expansion coefficient.

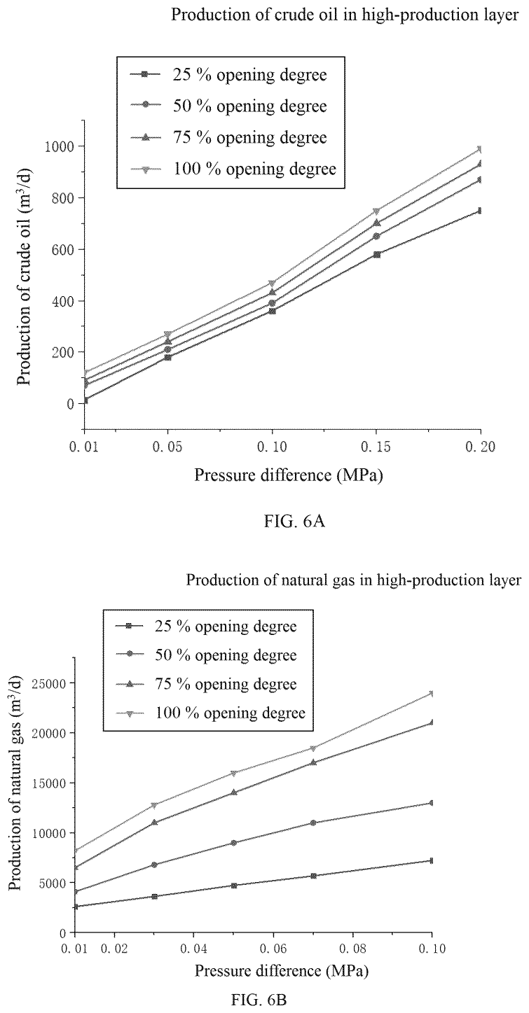

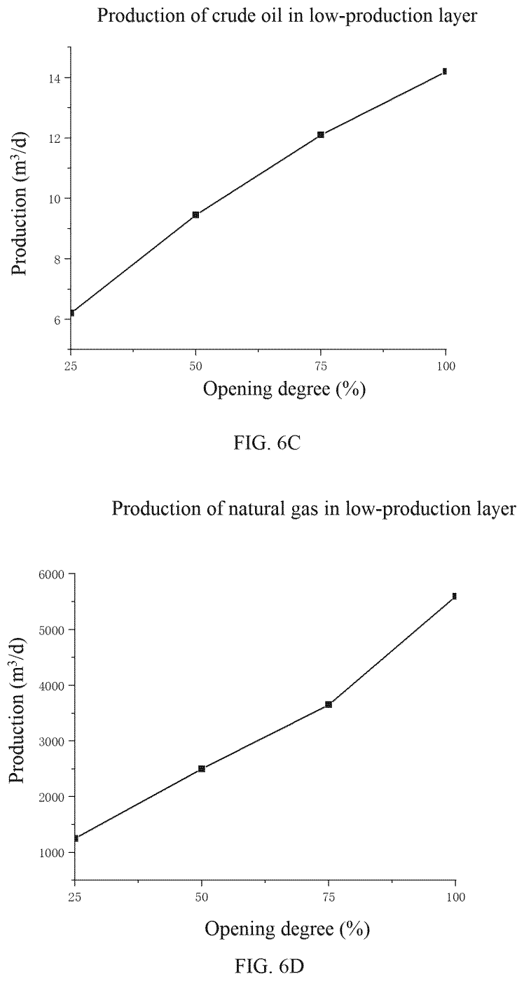

S2: numerical simulation method is adopted, the opening degrees of different throttles bores of the fluid control valve are changed, the inlet pressure is changed and the outlet pressure fixed respectively so as to simulate the production change of the single-layer fluid control valve under different pressure difference parameters, and the throttling performances of the fluid control valves of the high-production layers and low-production layers are evaluated respectively, so as to provide a basis for actual production engineering. FIG. 5 shows the boundary conditions of the single-layer fluid control valve, the fluid flows along a flow direction 5. FIGS. 6A to 6D show the production changes of crude oil and natural gas in the high-production layers and the low-production layers respectively.

S3: the flow field of a multi-layer fluid control valve is simulated, and the horizontal segment pressure drop of the multi-layer fluid control valve is simulated by using the horizontal segment orifice. The calculated orifice areas of the horizontal segment are as shown in Table 1.

TABLE 1
Calculation result table of orifice area of horizontal segment

| Valve spacing | 100 | 200 | 300 | 400 | 500 |
|---|---|---|---|---|---|
| Orifice radius (m) | 0.02364 | 0.01988 | 0.01797 | 0.01675 | 0.01581 |
| Orifice area (m²) | 0.00176 | 0.00124 | 0.00101 | 0.00088 | 0.00079 |

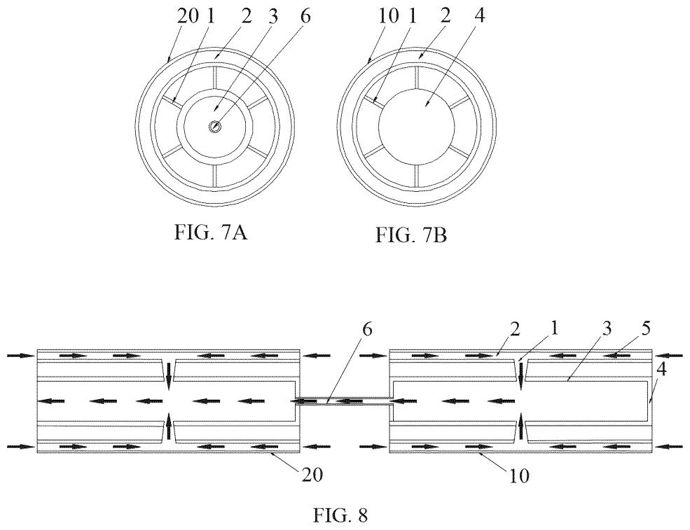

S4: a numerical simulation model of a multi-layer fluid control valve is established according to the orifice area of the horizontal segment calculated in step S3, and the fluid medium is natural gas and crude oil. FIGS. 7A and 7B show a numerical simulation model of the multi-layer fluid control valve which includes an orifice 1, a flow channel 2 of outer cylinder of fluid control valve, a flow channel 3 of inner cylinder of fluid control valve, an one side closure 4, an orifice 6 of horizontal segment, a fluid control valve 10 of primary layer and a fluid control valve 20 of other layer, the fluid enters from the flow channel of the outer cylinder of the fluid control valve and flows out from the flow channel of the inner cylinder of the fluid control valve through the orifices.

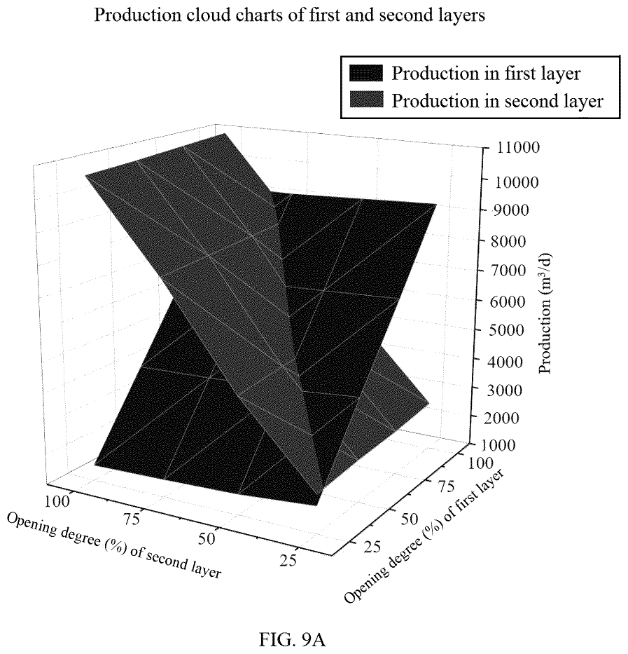

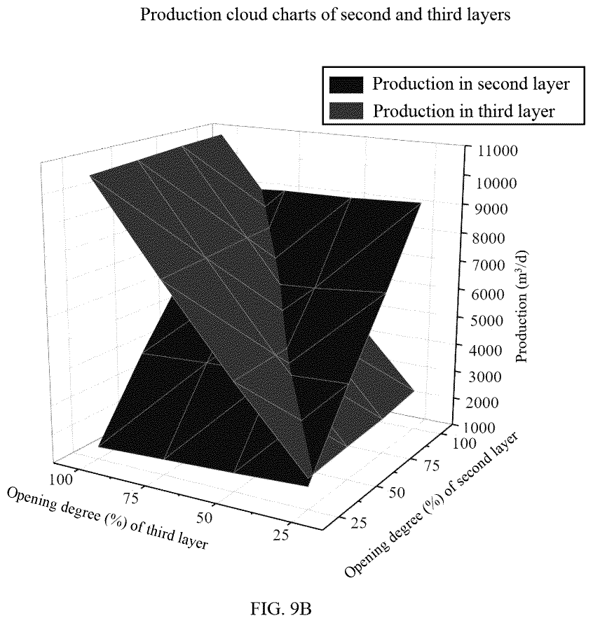

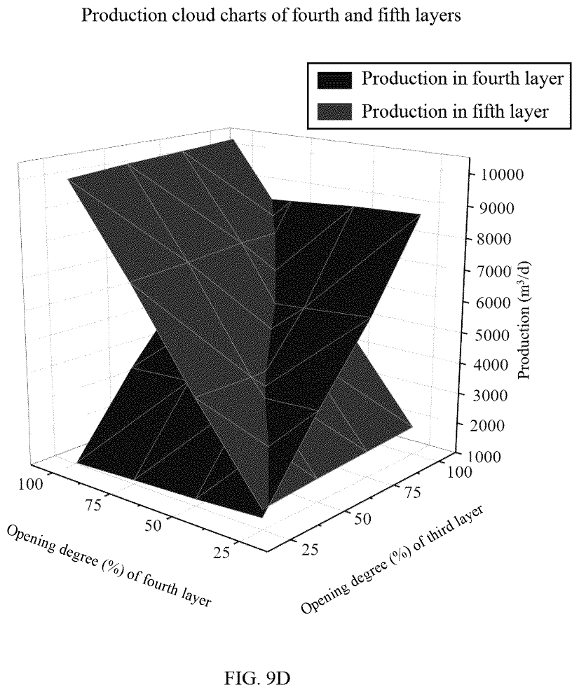

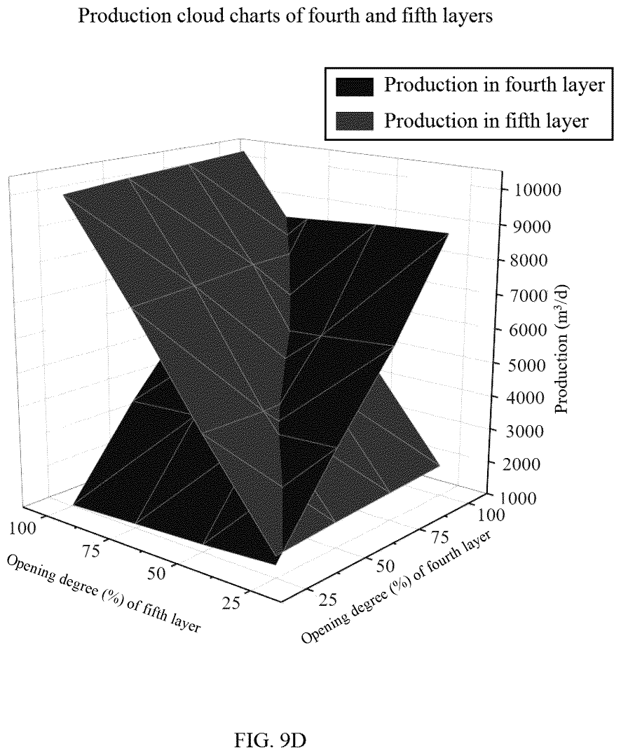

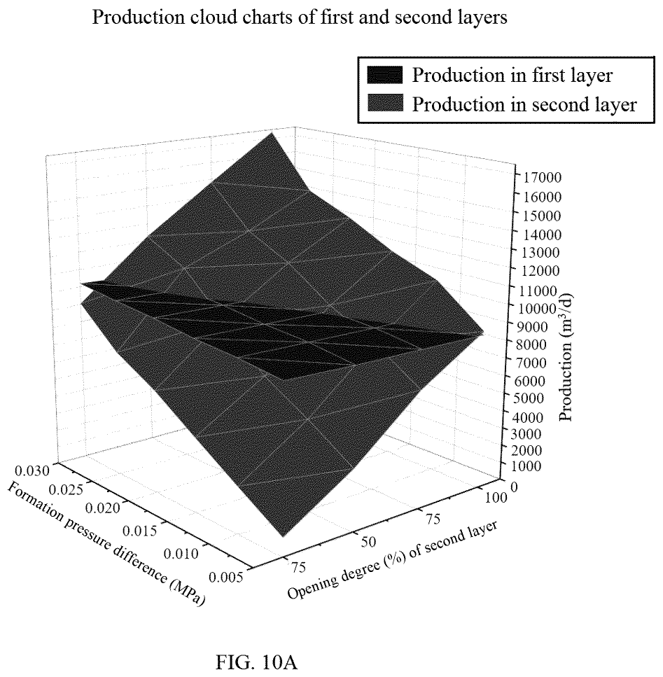

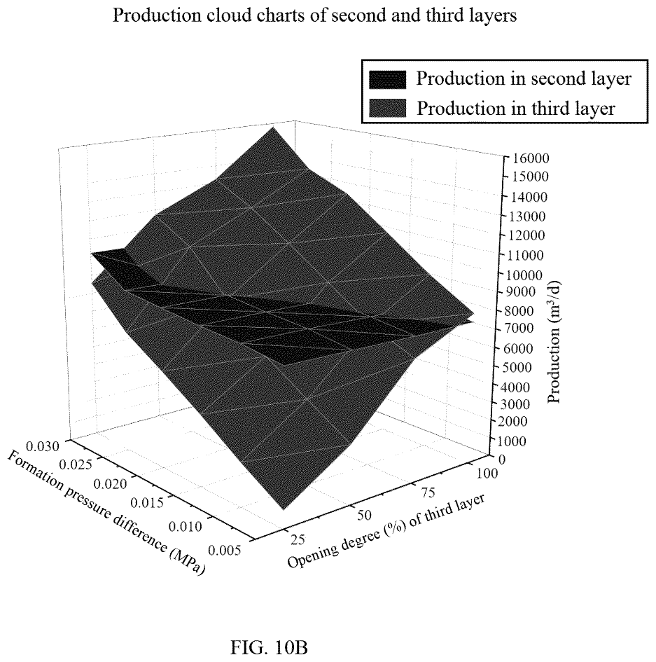

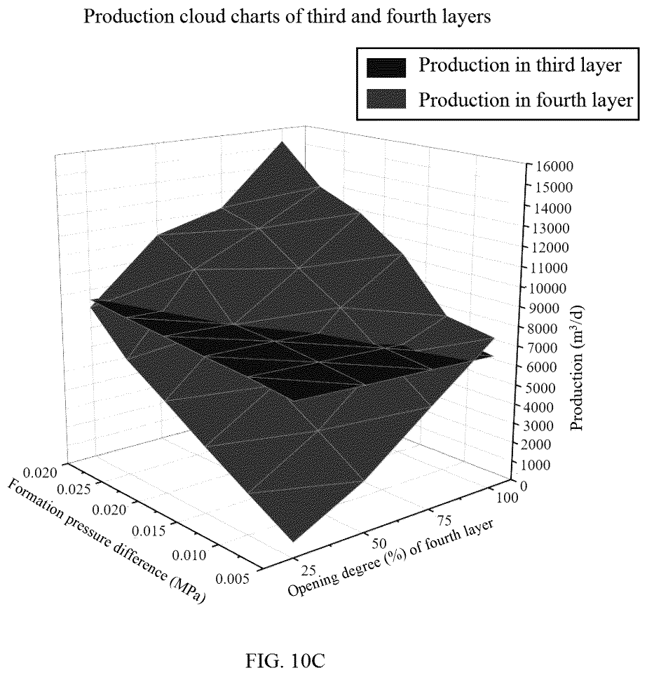

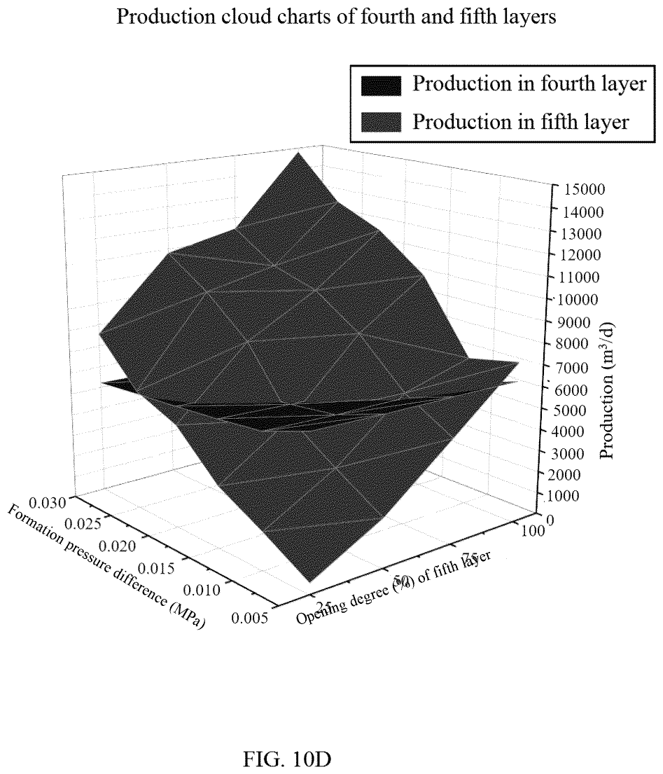

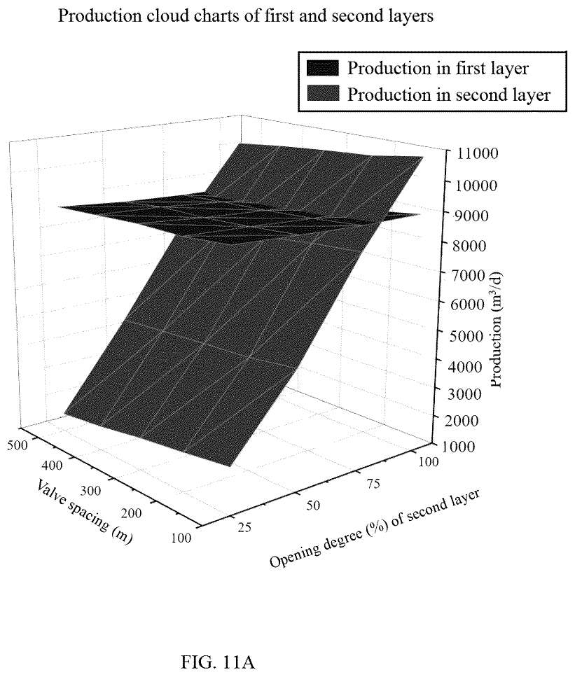

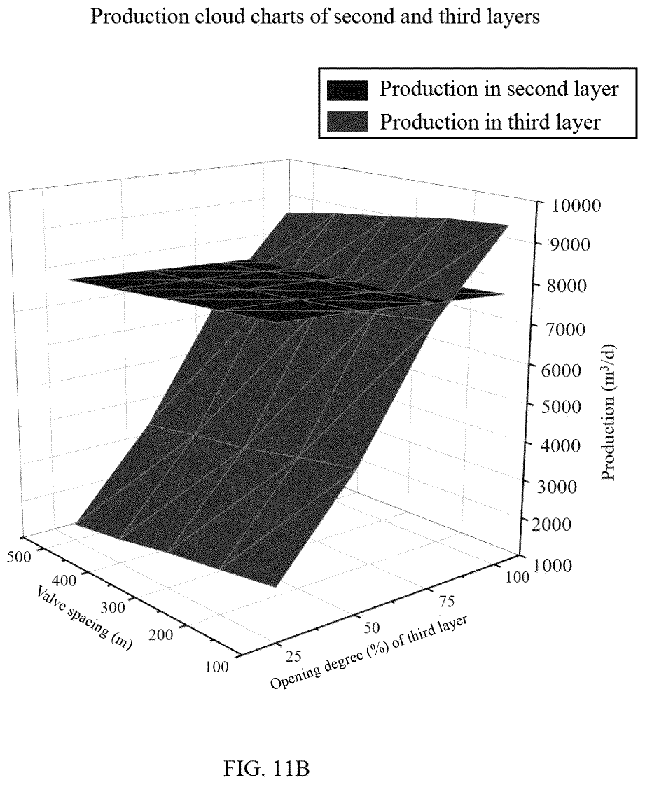

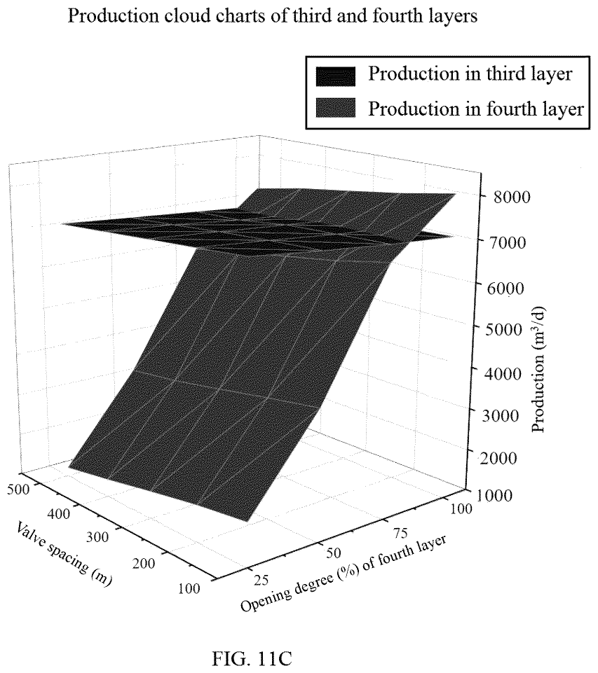

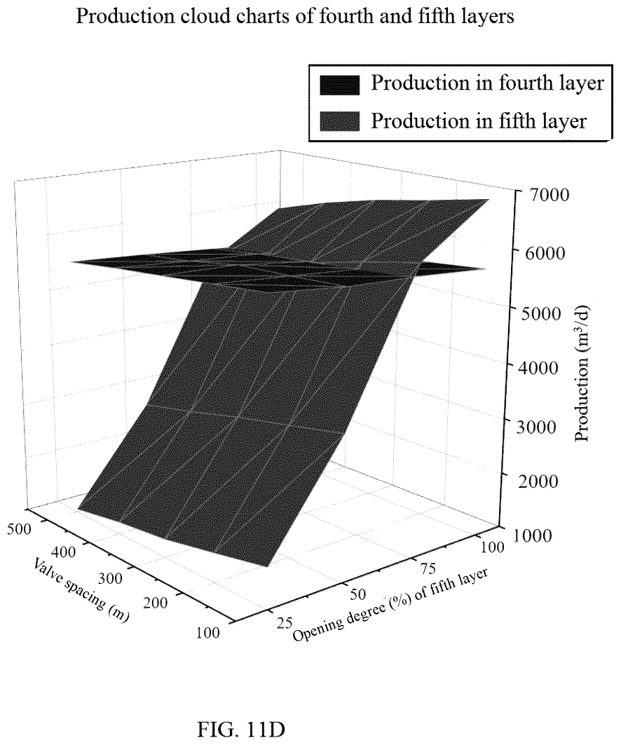

S5: according to the numerical simulation method, the parameters such as valve spacing, pressure difference, opening, etc. are adjusted. The mutual influence law between the opening degrees of each layer, the influence law of formation pressure on the opening degree in different formation segments and the influence law of different valve spacing on the opening degree are analyzed. FIG. 8 shows the boundary conditions of the multi-layer fluid control valve, the fluid flows along the flow direction 5. FIGS. 9A to 9D show the production cloud charts of each layer with the opening degree variation. FIGS. 10A to 10D show the production cloud charts of formation pressure difference and opening degree. And FIGS. 11A to 11D show the production cloud charts of valve spacing and opening degree.

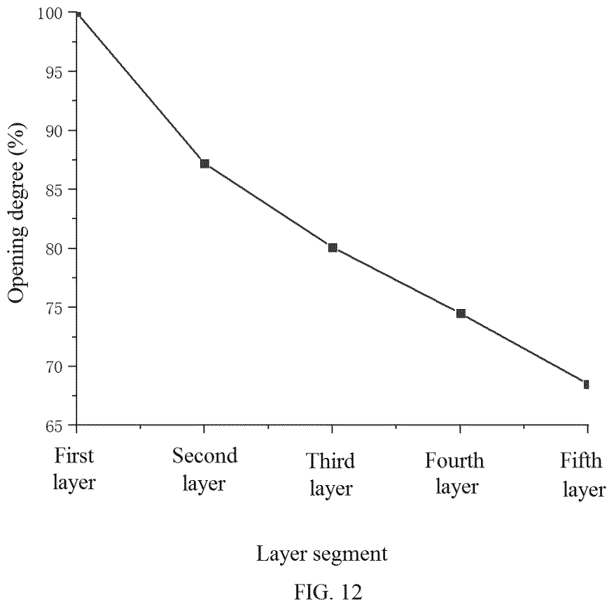

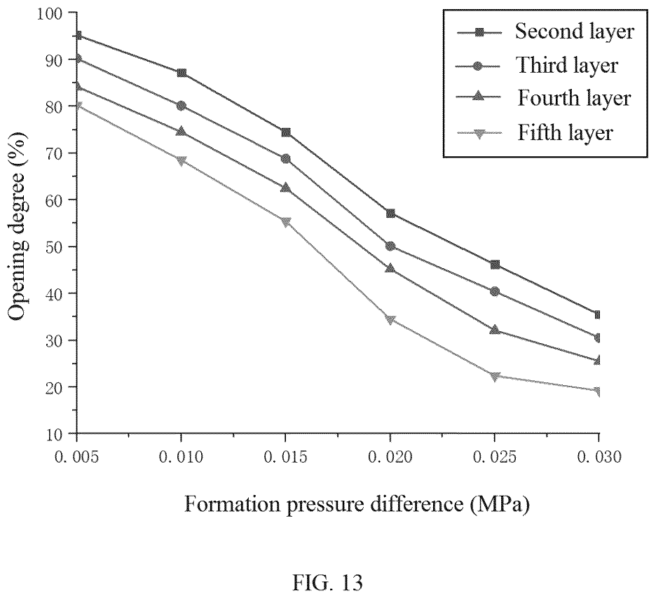

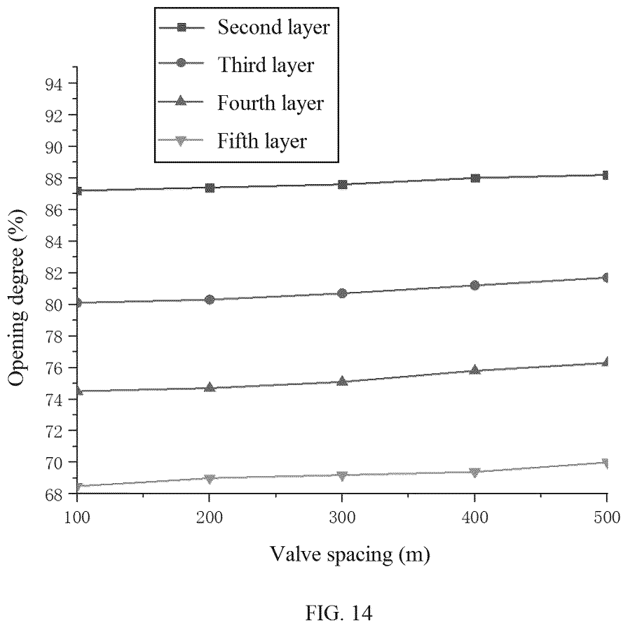

S6: according to the results obtained in step S5, when natural gas production is balanced, the relationship between opening degree, valve spacing and pressure difference is programmed. By inputting different valve spacings and pressure difference, the opening degree sizes of throttle holes during balanced production is obtained, which provides reference and theoretical support for actual production engineering, and respectively obtaining the change curve between layer segment and opening degree during balanced production as shown in FIG. 12, the change curve between formation pressure difference and the opening degree during balanced production shown in FIG. 13, and the change curve between valve spacing and opening degree during balanced production shown in FIG. 14, respectively.

In step S2, when simulating the production change of the single-layer fluid control valve under different pressure difference parameters, the opening degree of the orifice of the fluid control valve is set within the range of 0-100%, the outlet pressure is maintained, the inlet pressure is changed, and the pressure difference change is controlled to obtain the crude oil and natural gas production under different pressure differences.

In step S3, when the orifice of the horizontal segment is used to simulate the horizontal segment pressure drop of the multi-layer fluid control valve, the fluid flow regime is obtained first, then the friction coefficient of each segment of the horizontal well is calculated. And then the horizontal segment pressure drop is carried out according to the Fanning friction formula, and finally the throttling area of the horizontal well segment is calculated. Fanning friction coefficient calculation formula, Fanning friction formula and horizontal segment throttling area formula are as follows:

$$f = \frac{a}{R {e}^{b}}$$

$$Δ p = \frac{2 f ρ {v}^{2} L}{d}$$

$$A = \frac{q}{{C}_{q} \sqrt{Δ p \frac{2}{ρ}}}$$

Where L indicates the pipe length, m; d indicates the pipe diameter, m; p indicates the density of working fluid, kg/m³; v indicates the average flow rate of working fluid, m/s; f indicates Fanning friction coefficient, dimensionless; and Re indicates Reynolds number, dimensionless, when the fluid state is turbulent, n=1; Cq indicates the flow coefficient, dimensionless, and the circular hole flow coefficient is 0.82.

In step S6, when analyzing the mutual influence law between the opening degrees of each layer, the fluid control valves of each layer are arranged with a constant valve spacing, the inlet and outlet pressures are kept constant, and the orifice opening degrees of each layer are changed, so as to obtain the change results of natural gas production of each layer.

In step S6, when analyzing the influence law of formation pressure on the opening degree in different formation segments, the fluid control valves of each layer are arranged with a constant valve spacing, the outlet pressure is kept constant, the inlet pressure of different layers is changed, and the orifice opening degrees of each layer are adjusted, so as to obtain the change results of natural gas production of each layer.

In step S6, when analyzing the influence law of different valve spacings on the opening degree, the fluid control valves of each layer are arranged with different valve spacings, the outlet and inlet pressures are kept constant, and the orifice opening degrees of each layer are adjusted, so as to obtain the change results of natural gas production of each layer.

The step size of the orifice of the fluid control valve has an influence on the fluid flow and the dynamic response speed of the control valve. When the step size of the orifice is too large, the control accuracy of the valve will be reduced, because the change of the orifice will cause drastic changes in the pressure and velocity of the fluid, resulting to unstable flow and vortex, which would further reduce the control accuracy of the valve and may lead to the oscillation and impact of the pipeline. In addition, the step size of the orifice is too large, which will make it take longer for the control valve to reach the required opening degree, thereby reducing the dynamic response speed of the valve.

Therefore, during the simulation, different adjustment accuracy is simulated based on the opening degree Change of the orifices of the fluid control valve with different step sizes. Through the summary and analysis of the simulation results, the influence law of the opening degree adjustment step of the single-layer fluid control valve on oil and gas production is obtained. Then on this basis, the influence law of minimum opening degree adjustment step on oil and gas production is obtained.

Specifically, in step S101, based on the opening degree Change of the orifices of the fluid control valve with different step sizes, the simulation specifically includes the following steps.

The pressure difference of the fluid control valve is fixed; based on the opening degree Change of the orifices of the fluid control valve with different step sizes, the fluid control valves are divided into multiple groups, respectively corresponding to different adjustment accuracies, and the flow field of the fluid control valves of each group is numerically simulated.

During the simulation, the pressure difference is locked to reduce the influence of this parameter on the simulation results, and then the flow field of the fluid control valve is numerically simulated with the change of the orifice of the fluid control valve with different step sizes.

As the preferred implementation of this embodiment, the numerical simulation of the flow field can be divided into four groups, which correspond to the opening degree Change accuracy of the orifice of the fluid control valve with different step sizes. Among them, the first group takes the opening degree Changes with the step size of 25%, setting the opening degree of 100%, 75%, 50% and 25%, as a group. The second group takes the opening degree Changes with the step size of 5%, setting the opening degree of 100%, 95%, 90% and 85%, as a group. The third group takes the opening degree Changes with the step size of 4%, setting the opening degree of 100%, 96%, 92%, and 88%, as a group. The fourth group takes the opening degree Changes with the step size of 1%, setting opening degree of 100%, 99%, 98%, and 97%, as a group.

Further, in step S101, the step of obtaining the influence law of the opening degree adjustment step size of the single-layer fluid control valve on oil and gas production, and the influence law of the minimum opening degree adjustment step size on oil and gas production specifically includes the following steps.

The law result of the production change of each production layer and the opening degree adjusting step sizes of the fluid control valves in the simulation data of each group is calculated. From it, the opening degree adjustment accuracy that causes the smallest production change of each production layer is selected and determined as the minimum opening adjustment step. The production change corresponding to the minimum opening adjustment step size is set as the minimum error of balanced production.

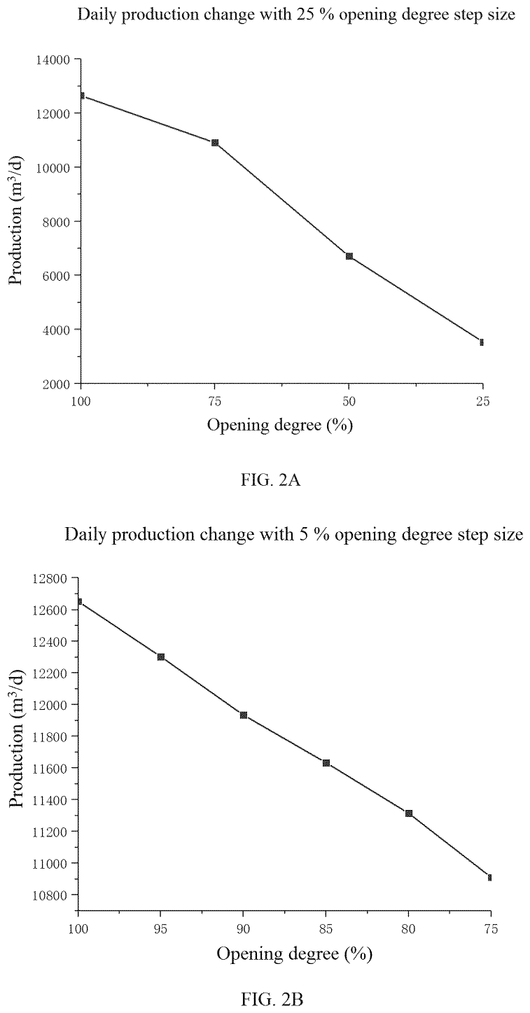

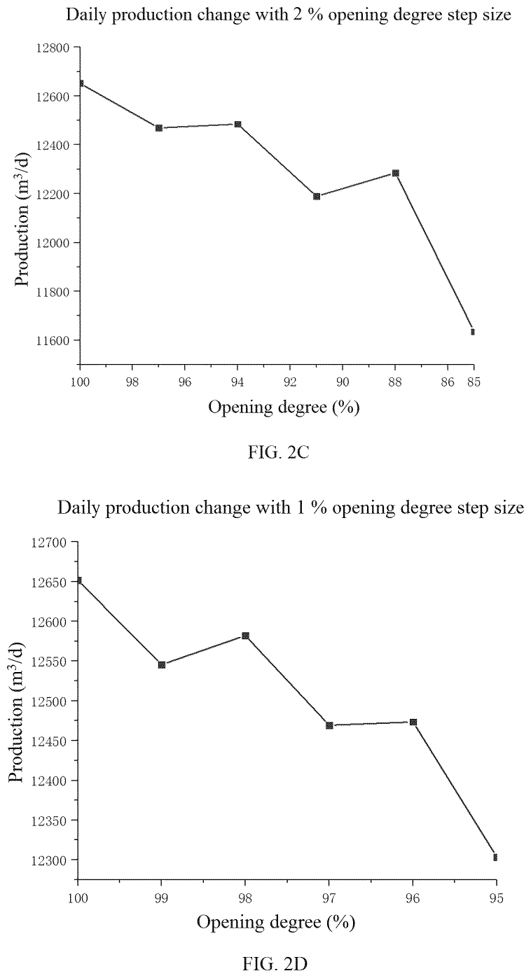

Based on the above grouping situation, the results of the adjustment step size law of the production change of production layers and the opening degree of four groups of the fluid control valves were compared and studied. And the minimum opening adjustment accuracy, that is, the minimum step size, which caused the significant production change of each production layer was selected. Then, the selected production change corresponding to the minimum opening adjustment step is set as the minimum error Δx of balanced production, which is used for subsequent opening degree Calculation. The specific example is shown in FIGS. 2A to 2D. The minimum adjustment step size of this fluid control valve is 5%, and the corresponding minimum error Δ of balanced production is 2.7%.

The main purpose of step S101 is to determine the minimum error Δx of balanced production of fluid control valves for subsequent calculation. For unused fluid control valves, due to possible differences in its structure, it is necessary to calculate the corresponding minimum error Δx of balanced production based on the results of the above simulation.

Step S102: The production test data of the oil and gas well equipped with fluid control valves are obtained by testing oil and gas via a layering system.

The production test data of the oil and gas well include a formation pressure, a bottom hole flowing pressure, a test production and formation parameters. Taking an oil and gas well as an example, the formation parameters of this oil and gas well are shown in Table 2 below.

TABLE 2
Formation parameters

| Type of production | Natural gas | | Natural gas | 0.67 | kg/m³ |
|---|---|---|---|---|---|
| formation | | | density | | |
| Number of | 15 | | Natural gas | 0.03 | mPa · s |
| production | | | viscosity | | |
| formation | | | | | |
| Production formation | 2416.8 | m | Production | 1008 | m |
| depth | | | layer length | | |
| Average distance of | 67.2 | m | Total | 60000 | m³/d |

| | |
|---|---|
| production formation | production |

Step S103, the production capacity of each production layer of the oil and gas well based on the test data is evaluated, so as to obtain the total production of the oil and gas well and the production of each production layer, and each production layer is numbered in sequence.

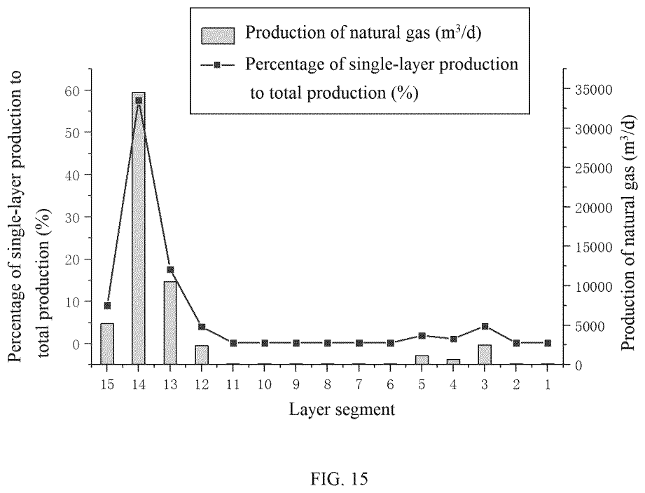

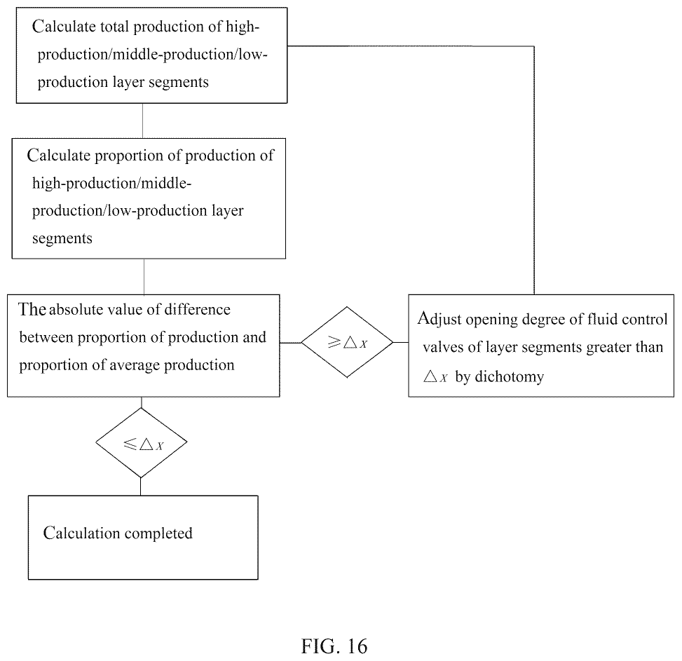

By numbering, it is convenient to determine the production layers for subsequent opening calculations. As shown in FIG. 15, 15 production layers of a certain oil and gas well are numbered in sequence.

Step S104, the percentage of the production of each production layer to the total production is calculated. Based on the percentage of the production of each production layer to the total production, the production layers is divided into high-production layers, middle-production layers, and low-production layers. The average productions of the high-production layers, middle-production layers, and low-production layers are calculated respectively.

High-production, middle-production, and low-production layers respectively correspond to production layers with a certain proportion of total production, and the specific threshold interval used for division can be determined based on the actual situation of oil and gas wells. As shown in FIG. 15, for the numbered production layers, after calculating the percentage of production to total production, the 15th, 14th, and 13th layers are classified as high-production layers, the 12th, 5th, 4th, and 3rd layers are classified as the middle-production layers, and the rest are classified as the low-production layers.

Step S105, based on the above calculation results, the opening degree of the orifices of each fluid control valve is calculated by dichotomy when productions of each production layer are balanced.

Specifically, the calculation formula of dichotomy is:

$$\vert \frac{f ( {x}_{i} )}{F ( {x}_{k} )} - \overline{\frac{f ( {x}_{k} )}{F ( {x}_{k} )}} \vert \leq Δ x , i = 1 , 2 , 3 … n$$

Where xₖ indicates different types of production layer segments, and the value of k corresponds to high, middle and low-production layers; x; indicates the i-th production layer, and the value of i is 1, 2, 3 . . . n; F(xₖ) indicates the total oil and gas production of different types of production layers; F(xᵢ) indicates the oil and gas production of the i-th production layer; f̅(̅x̅ₖ̅)̅ indicates the average oil and gas production of various types of production layers; Δx indicates the minimum error of balanced production.

Specifically, the high-production layers, middle-production layers and low-production layers are adjusted and calculated respectively. The opening degree of each layer segment is adjusted from full opening of 100%, and the opening is reduced by half in turn, that is, the production of each production layer is adjusted by the opening degree of 100%, 50%, 25%, 12.5% and 6.25% in sequence (at least greater than the minimum adjustment step), until the difference between the percentage of production of each layer to the total production and the percentage of average production to the total production is less than the minimum error of balanced production. At this time, it is considered that balanced production has been achieved, and the corresponding execution logic is shown in FIG. 16.

It should be noted that every time the opening degree is adjusted by dichotomy, the adjusted production and proportion of each production layer are obtained by real-time simulation, and then the production layer that does not meet the requirements is adjusted by dichotomy.

As a preferred implementation of the present disclosure, in order to make the difference between the percentage of production of each layer to the total production and the percentage of average production to the total production less than the minimum error of balanced production, only the dichotomy method is used to calculate the production layers with the difference of production percentage exceeding the minimum error of balanced production each time.

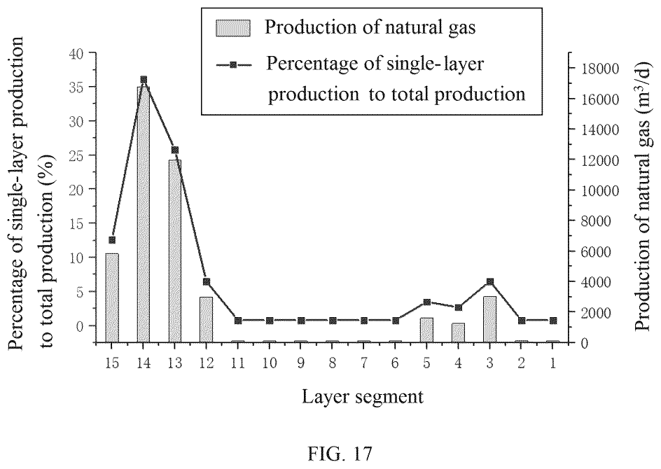

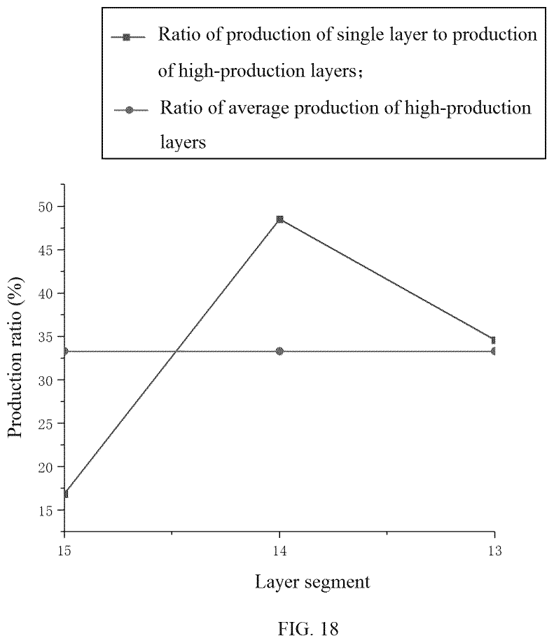

If the production of the corresponding production layer is greater than the average production of that type of production layer, reduce the opening degree of the corresponding production layer. As shown in FIGS. 17 and 18, FIG. 17 shows the production and proportion of each production layer after an opening adjustment of the 14th production layer by dichotomy once during adjustment of the high-production layers. FIG. 18 shows the ratio of the production of each layer of the corresponding high-production layer segment to the total production of the high-production layer segment.

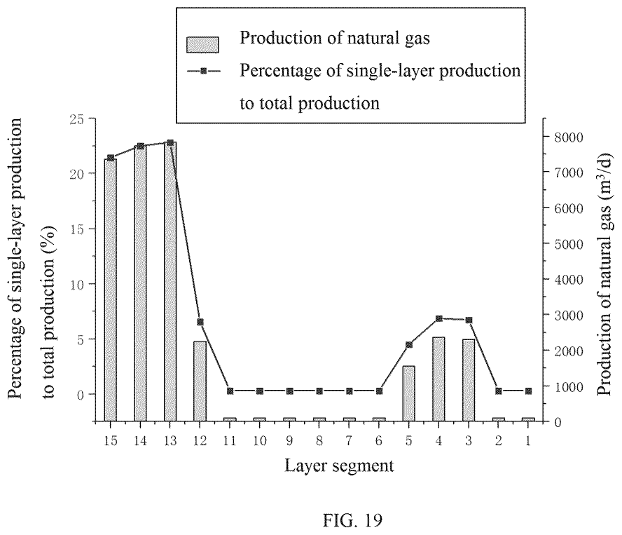

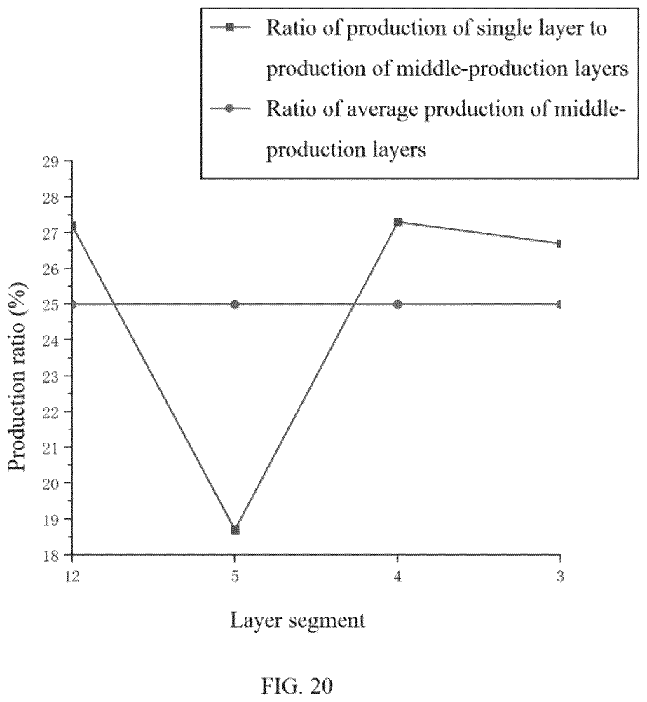

If the production of the corresponding production layer is less than the average production of that type of production layer, the opening degree of the corresponding production layer is increased. As shown in FIGS. 19 and 20, FIG. 19 shows the production of each layer and the ratio of the production of each layer to the total production after the 12th, 5th, and 3rd layers are adjusted by dichotomy during adjustment of the middle-production layers. FIG. 20 shows the ratio of each layer's production of the corresponding middle-production layer segment to the total production of the middle-layer segment. The next step is to increase the opening degree of the 5th layer by dichotomy.

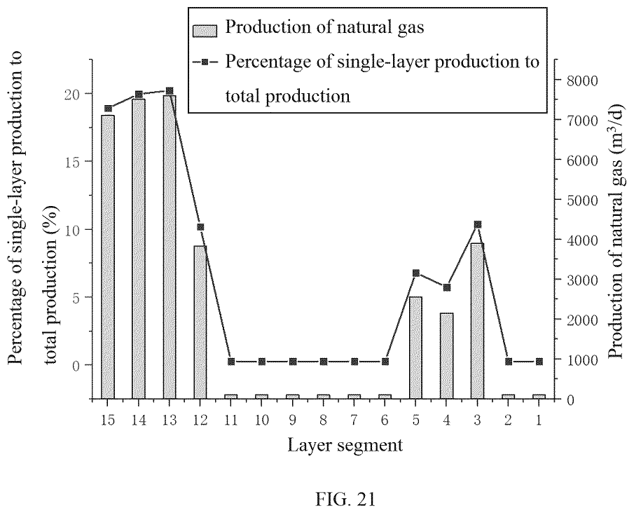

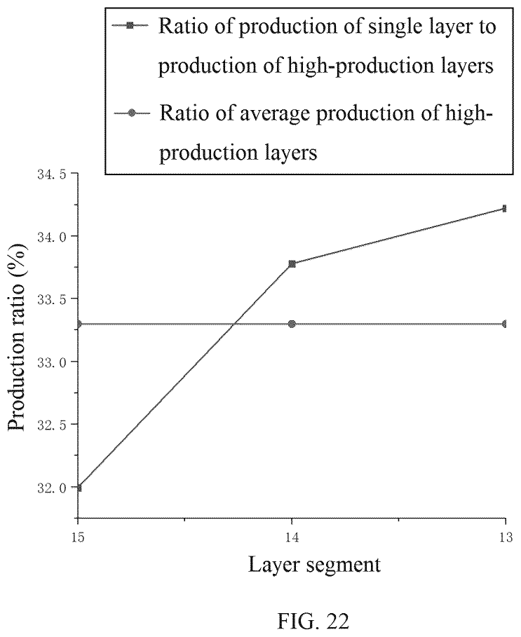

Furthermore, for layer segment where the production is less than the average production and the opening degree has increased by 100%, the opening degree of that layer segment is kept unchanged. The other layer segment where the difference of the production percentages exceeds the minimum error of balanced production is adjusted. Based on the FIG. 18, it can be seen that the next adjustment needs to keep the opening degree of the 15th layer unchanged, and the opening degree of the 14th and 13th layers is adjusted. FIGS. 21 and 22 respectively show the production of each production layer and proportion of the production to the total production and the proportion of each layer of the corresponding high-production layers after dichotomies on the 14th layers three times and dichotomy on the 13th layers once. From FIGS. 21 and 22, it can be seen that the proportion of each layer in the high-production layer segment is already lower than the average proportion, and the high-production layer segment has reached balanced production. The same applies to the adjustment of the middle-production and low-production layer segments.

On the basis of the above, for multiple production layers with the same production and opening degree, and the difference of production percentage exceeding the minimum error of balanced production, they are numbered in sequence and the opening degree is adjusted through the following formula:

$${T}_{N} = \frac{{T}_{0}}{{2}^{N}} , N = 1 , 2 , 3 , 4$$

Where T_{N} indicates the opening degree of the orifice of the fluid control valve in different layers, and T_{N}≥6.25%; N indicates the layer segment number; T₀ indicates the opening degree of the fluid control valve in the current layer, and T₀≥6.25%; when the value of N is greater than 4, T₀ is 6.25%.

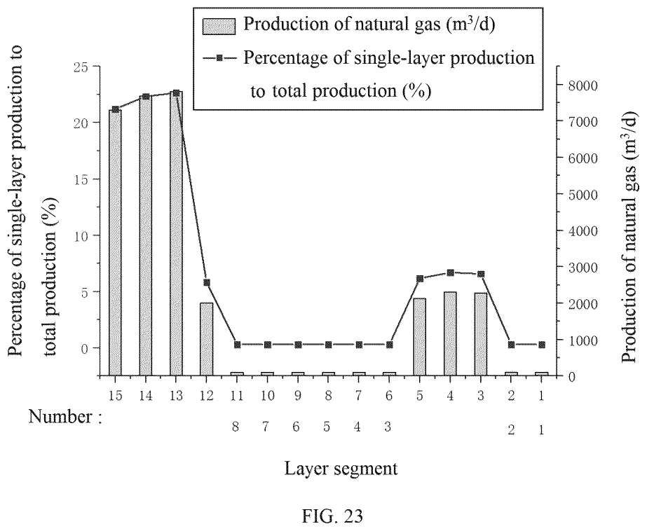

The specific implementation situation is shown in FIG. 23. FIG. 23 is a schematic diagram of numbering the low-production layers again after both the high-production layers and middle-production layers reach balanced production. After numbering each production layer of the low-production layer again, the above formula is used for calculation and adjustment of the opening degree.

In summary, the method for automatically adjusting the opening degree of the fluid control valve provided in this embodiment can be applied to various fluid control valves with throttle hole structures. Various adjustment accuracies are simulated through the opening changes of the orifices of the fluid control valve with different step sizes. And influence law of the minimum opening degree adjustment accuracy on oil and gas production is obtained. This method can be applied to various fluid control valves and is simple and effective, the minimum opening degree of the orifice and minimum error in balanced production caused by fluid control valves for oil and gas production changes can be quickly obtained. The binary method is adopted to automatically adjust the opening degree of the fluid control valve to adapt to different production layers, thereby achieving the goal of balanced production. This method can be applied to various types of oil and gas wells, the reliability and feasibility of setting the opening degree of orifice of the fluid control valve are increased.

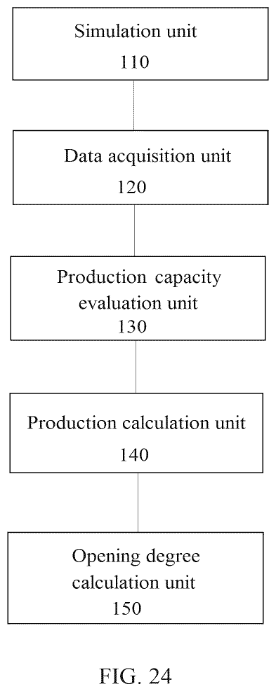

As shown in FIG. 24, the apparatus for automatically adjusting the opening degree of the fluid control valve provided by the present disclosure is applied to the fluid control valves each with an orifice structure in an oil and gas production, and the apparatus includes the following units.

The simulation unit 110 is used to perform simulation based on the opening degree Changes of the orifices of the fluid control valves with different step sizes, obtain the influence law of the opening degree adjustment step of the single-layer fluid control valve on oil and gas production, and obtain the influence law of the minimum opening degree adjustment step size on oil and gas production.

The data acquisition unit 120 is used to obtain production test data of the oil and gas well equipped with fluid control valves through testing oil and gas via the layering system.

The production capacity evaluation unit 130 is used to evaluate the production capacity of different production layers of the oil and gas well based on the production test data, obtain the total production of the oil and gas well and the productions of different production layers, and number each production layer in sequence.

The production calculation unit 140 is used to calculate the percentage of production of each production layer to the total production, divide the production layers into high-production layers, middle-production layers, and low-production layers based on the percentage of production of each production layer to the total production, calculate the average productions of the high-production layer, middle-production layer, and low-production yield layer respectively.

The opening degree Calculation unit 150 is used to calculate the opening of the orifices of each fluid control valve by dichotomy when productions of the production layers are balanced based on the above calculation results.

The apparatus for automatically adjusting the opening degree of the fluid control valve provided in the embodiments of the present disclosure is used to achieve the method for automatically adjusting the opening degree of the fluid control valve mentioned above. Therefore, the specific implementation of the apparatus is the same as that of the above method and is not repeated herein.

The present disclosure further provides a system for automatically adjusting the opening degree of the fluid control valve, including:
one or more fluid control valves each with an orifice structure in oil and gas production; and
a fluid control valve control module for controlling the opening degree each of the fluid control valves.

The fluid control valve control module in the present disclosure includes one or more of the following components: a processor, a memory, and one or more application programs. The one or more application programs can be stored in the memory and configured to be executed by one or more processors, and the one or more application programs are configured to execute the method described in the aforementioned method embodiment.

The processor may include one or more processing cores. The processor uses various interfaces and circuits to connect various parts of the whole fluid control valve control module. By running or executing instructions, programs, code sets or instruction sets stored in memory, as well as calling data stored in memory, it executes various functions and processes data of the fluid control valve control module. Optionally, the processor can be implemented in at least one hardware form, including Digital Signal Processing (DSP), Field-Programmable Gate Array (FPGA), or Programmable Logic Array (PLA). The processor can integrate one or several combinations of Central Processing Unit (CPU), Graphics Processing Unit (GPU), and modem. Among them, the CPU mainly handles operating systems, user interfaces, and application programs, etc. GPU is used for rendering and drawing display content. The modem is used to handle wireless communication. It can be understood that the above modems can also be implemented separately through a communication chip without being integrated into the processor.

The memory can include either Random Access Memory (RAM) or Read-Only Memory. The memory can be used to store instructions, programs, code, code sets, or instruction sets. The memory can include a storage program area and a storage data area. The storage program area may store instructions for implementing the operating system, instructions for implementing at least one function (such as touch function, sound playback function, image playback function, etc.), and instructions for implementing the following method embodiments, etc. The storage data area can also store data created by the terminal during use (such as phone books, audio and video data, chat record data), etc.

In summary, the present disclosure provides a method, an apparatus, and a system for automatically adjusting the opening degree of the fluid control valve, which can be applied to various fluid control valves each with the orifice structure. Various adjustment accuracies are simulated through the opening changes of the orifice of the fluid control valve with different step sizes. And influence law of the minimum opening degree adjustment accuracy on oil and gas production is obtained. This method can be applied to various fluid control valves and is simple and effective, the minimum opening degree of the orifice and minimum error in balanced production caused by fluid control valves for oil and gas production changes can be quickly obtained. The binary method is adopted to automatically adjust the opening degree of the fluid control valve to adapt to different production layers, thereby achieving the goal of balanced production. This method can be applied to various types of oil and gas wells, the reliability and feasibility of setting the opening degree of orifice of the fluid control valve are increased.

In the embodiments disclosed in the present disclosure, it should be understood that the disclosed apparatus and method can also be implemented in other ways. The above described embodiments of the apparatus are only illustrative. For example, the flowchart and block diagram in the accompanying drawings show the possible architecture, functions, and operations of the apparatus, method, and computer program product according to multiple embodiments of the present disclosure. At this point, each block in a flowchart or block diagram can represent a module, program segment, or part of code, which contains one or more executable instructions used to implement the specified logical functions. It should also be noted that in some alternative implementations, the functions indicated in the block can also occur in a different order than those indicated in the accompanying drawings. For example, two consecutive blocks can actually be executed in basic parallel, and sometimes they can also be executed in opposite order, depending on the functionality involved. It should also be noted that each block in the block diagram and/or flowchart, as well as the combination of blocks in the block diagram and/or flowchart, can be implemented using dedicated hardware based systems that perform specified functions or actions, or can be implemented using a combination of dedicated hardware and computer instructions.

In addition, the various functional modules in the embodiments of the present disclosure can be integrated together to form an independent part, or each module can exist separately, or two or more modules can be integrated to form an independent part.

If the functions are implemented in the form of software functional modules and sold or used as independent products, they can be stored in a computer-readable storage medium. Based on this understanding, the technical solution of the present disclosure, in essence, or the portion that contributes to the prior art or the portion of the technical solution, can be reflected in the form of a software product, which is stored in a storage medium, including several instructions to enable a computer device (which can be a personal computer, server, or network device, etc.) to perform all or part of the steps of the methods described in various embodiments of the present disclosure. The aforementioned storage media include: USB flash drives, portable hard drives, Read-Only Memory (ROM), Random Access Memory (RAM), disks or CDs, and other media that can store program code.

1. A method for automatically adjusting an opening degree of a fluid control valve, applying to fluid control valves each with an orifice structure in oil and gas production, comprising:
performing simulation based on an opening degree Change of orifices of each of the fluid control valves with different step sizes, obtaining an influence law of an opening degree adjustment step size of a single-layer fluid control valve on oil and gas production, and an influence law of a minimum opening degree adjustment step size on oil and gas production;
testing oil and gas via a layering system, so as to obtain production test data of an oil and gas well equipped with the fluid control valves;
evaluating production capacity of each of production layers of the oil and gas well based on the production test data, so as to obtain a total production of the oil and gas well and a production of each of the production layers, and numbering each of the production layers in sequence;
calculating a percentage of the production of each of the production layers to the total production, and dividing the production layers into high-production layers, middle-production layers and low-production layers based on the percentage of the production of each of the production layers to the total production; calculating average productions of the high-production layers, the middle-production layers and the low-production layers respectively;
calculating an opening degree of the orifices of each of the fluid control valves by dichotomy when productions of the production layers are balanced based on above calculation results.

2. The method for automatically adjusting an opening degree of a fluid control valve according to claim 1, wherein the performing simulation based on the opening degree Change of orifices of each of the fluid control valves with different step sizes comprises:
fixing a pressure difference of each of the fluid control valves;
dividing the fluid control valves into a plurality of groups respectively corresponding to different adjustment accuracies, based on the opening degree Change of the orifices of each of the fluid control valves with different step sizes, and numerically simulating a flow field of the fluid control valves of each of the plurality of groups.

3. The method for automatically adjusting an opening degree of a fluid control valve according to claim 1, wherein the production test data of the oil and gas well comprises a formation pressure, a bottom hole flowing pressure, a test production, and formation parameters.

4. The method for automatically adjusting an opening degree of a fluid control valve according to claim 2, wherein the obtaining the influence law of the opening degree adjustment step size of the single-layer fluid control valve on oil and gas production, and the influence law of the minimum opening degree adjustment step size on oil and gas production comprises:
calculating a law result of a production change of each of the production layers and opening degree adjusting step sizes of the fluid control valves in simulation data of each of the groups; selecting an opening degree adjustment accuracy which causes a smallest production change of each of the production layers and determining the opening degree adjustment accuracy as a minimum opening degree adjustment step size; setting a production change corresponding to the minimum opening degree adjustment step size as a minimum error of balanced production.

5. The method for automatically adjusting an opening degree of a fluid control valve according to claim 2, wherein the performing simulation comprises:
S1, adopting a numerical simulation method to change the opening degree of the orifices of each of the fluid control valves and an inlet pressure and fixing an outlet pressure, so as to to simulate a production change of the single-layer fluid control valve under different pressure difference parameters; and evaluating a throttling performance of the fluid control valves of each of the high-production layers and the low-production layers, so as to provide a basis for actual production engineering;
S2, simulating a flow field of a multi-layer fluid control valve, and simulating a pressure drop of a horizontal segment of the multi-layer fluid control valve by using a horizontal segment orifice;
S3, establishing a numerical simulation model of the multi-layer fluid control valve based on an area of the horizontal segment orifice calculated in S2, setting natural gas and crude oil as a fluid medium;
S4, adjusting a valve spacing, the pressure difference and the opening degree based on the numerical simulation method, analyzing a mutual influence law between opening degrees of the production layers, an influence law of formation pressure on the opening degree in different layer segments and an influence law of different valve spacings on the opening degree;
S5, based on results obtained in S4, programming a relationship between the opening degree, the valve spacing and the pressure difference when natural gas production is balanced, obtaining a size of the opening degree of the orifices during balanced production by inputting different valve spacings and pressure differences, so as to provide reference and theoretical support for actual production engineering.

6. The method for automatically adjusting an opening degree of a fluid control valve according to claim 4, wherein the calculating the opening degree of the orifices of each of the fluid control valves by dichotomy when productions of the production layers are balanced comprises:
adjusting and calculating the high-production layers, the middle-production layers and the low-production layers respectively; adjusting the opening degree of each of layer segments from full opening of 100%, and reducing the opening degree by half in turn, that is, adjusting the production of each of the production layers by the opening degree of 100%, 50%, 25%, 12.5% and 6.25% in sequence, until a difference between the percentage of the production of each of the production layers to the total production and the percentage of average production to the total production is less than the minimum error of balanced production;
obtaining an adjusted production and a proportion of each of the production layers by real-time simulation after adjusting the opening degree by dichotomy, and further adjusting production layers which fail to meet requirement by dichotomy;
a calculation formula of the dichotomy is:
$$\vert \frac{f ( {x}_{i} )}{F ( {x}_{k} )} - \overline{\frac{f ( {x}_{k} )}{F ( {x}_{k} )}} \vert \leq Δ x , i = 1 , 2 , 3 … n$$
wherein, xₖ indicates different types of production layer segments, and the value of k corresponds to high, middle and low-production layers; xᵢ indicates an i-th production layer, and a value of i is 1, 2, 3 . . . n; F(xₖ) indicates the total oil and gas production of different types of production layers; F(xᵢ) indicates an oil and gas production of the i-th production layer; f̅(̅x̅ₖ̅)̅ indicates an average oil and gas production of the types of production layer segments; Δx indicates the minimum error of balanced production.

7. The method for automatically adjusting an opening degree of a fluid control valve according to claim 5, wherein, before adopting the numerical simulation method to change the opening degree of the orifices of each of the fluid control valve, based on a structure and working principle of the fluid control valves, establishing and simplifying the numerical simulation model of the single-layer fluid control valve by combining with actual working conditions of the fluid control valves in different production layers under an intelligent well; selecting crude oil and natural gas as a fluid material to obtain a fluid flow state and fluid rheological parameters.

8. The method for automatically adjusting an opening degree of a fluid control valve according to claim 6, wherein the calculating the opening degree of the orifices of each of the fluid control valves by dichotomy when productions of the production layers are balanced further comprises:
calculating the production layers with a difference of production percentage exceeding the minimum error of balanced production each time;
reducing an opening degree of a corresponding production layer when a production of the corresponding production layer is greater than the average production of the production layers; increasing an opening degree of the corresponding production layer when the production of the corresponding production layer is less than the average production of the production layers.

9. The method for automatically adjusting an opening degree of a fluid control valve according to claim 6, further comprising:
maintaining an opening degree of a production layer, the production of the production layer being less than the average production and opening degree being of 100%; and adjusting a production layer with a difference of a production percentage exceeding the minimum error of balanced production.

10. The method for automatically adjusting an opening degree of a fluid control valve according to claim 7, wherein the fluid rheological parameters comprise viscosity, density, specific heat capacity, thermal conductivity, and thermal expansion coefficient of 0 to 100%.

11. The method for automatically adjusting an opening degree of a fluid control valve according to claim 8, further comprising:
for a plurality of production layers with a same production and opening degree, and a difference of a production percentage exceeding the minimum error of balanced production, numbering the plurality of production layers in sequence, and adjusting the opening degree through a formula:
$${T}_{N} = \frac{{T}_{0}}{{2}^{N}} , N = 1 , 2 , 3 , 4$$
wherein T_{N} indicates an opening degree of an orifice of a fluid control valve in different layers, and T_{N}≥6.25%; N indicates a layer segment number; T₀ indicates an opening degree of a fluid control valve in a current layer, and T₀≥6.25%; when a value of N is greater than 4, T₀ is 6.25%.

12. The method for automatically adjusting an opening degree of a fluid control valve according to claim 10, when simulating the production change of the single-layer fluid control valve under different pressure difference parameters in S1, setting the opening degree of the orifices of each of the fluid control valves within the range of 0-100%, fixing the outlet pressure, changing the inlet pressure, and controlling a pressure difference change to obtain a crude oil and natural gas production under different pressure differences.

13. The method for automatically adjusting an opening degree of a fluid control valve according to claim 10, when simulating the pressure drop of the horizontal segment of the multi-layer fluid control valve by using the horizontal segment orifice in S2, obtaining a fluid flow regime, calculating a friction coefficient of each segment of a horizontal well, carrying out a pressure drop of horizontal well segment based on Fanning friction formula, and calculating an orifice area of the horizontal well segment; Fanning friction coefficient calculation formula, Fanning friction formula and formula of orifice area of the horizontal well segment are:
$$f = \frac{a}{R {e}^{b}}$$
$$Δ p = \frac{2 f ρ {v}^{2} L}{d}$$
$$A = \frac{q}{{C}_{q} \sqrt{Δ p \frac{2}{ρ}}}$$
wherein L indicates a pipe length, m; d indicates a pipe diameter, m; p indicates density of working fluid, kg/m³, v indicates an average flow rate of working fluid, m/s; f indicates Fanning friction coefficient, dimensionless; and Re indicates Reynolds number, dimensionless, when fluid state is turbulent, n=1; Cq indicates flow coefficient, dimensionless, and circular hole flow coefficient is 0.82.

14. The method for automatically adjusting an opening degree of a fluid control valve according to claim 10, wherein when analyzing the mutual influence law between the opening degrees of production layers in S4, arranging the fluid control valves of each of the production layers with a constant valve spacing, keeping the inlet and outlet pressures constant, and changing an orifice opening degree of each of the production layers, so as to obtain change results of natural gas production of each of the production layers.

15. The method for automatically adjusting an opening degree of a fluid control valve according to claim 10, when analyzing the influence law of formation pressure on the opening degree in different layer segments in S4, arranging the fluid control valves of each of production layers with a constant valve spacing, keeping the outlet pressure constant, changing the inlet pressure of different layers, and adjusting the orifice opening degree of each of the production layers, so as to obtain change results of natural gas production of each of the production layers.

16. The method for automatically adjusting an opening degree of a fluid control valve according to claim 10, when analyzing the influence law of different valve spacings on the opening degree in S4, arranging the fluid control valves of each of the production layers with different valve spacings, keeping the outlet pressure and the inlet pressure constant, and adjusting the orifice opening degree of each of the production layers, so as to obtain change results of natural gas production of each of the production layers.

17. An apparatus for automatically adjusting an opening degree of a fluid control valve, applying to fluid control valves each with an orifice structure in oil and gas production, comprising:
a simulation unit used for performing simulation based on an opening degree Change of orifices of each of the fluid control valves with different step sizes, obtaining an influence law of an opening degree adjustment step size of a single-layer fluid control valve on oil and gas production, and obtaining an influence law of a minimum opening degree adjustment step size on oil and gas production;
a data acquisition unit used for obtain production test data of an oil and gas well equipped with fluid control valves through testing oil and gas via a layering system;
a production capacity evaluation unit used for evaluating production capacity of each of the production layers of the oil and gas well based on the production test data, obtaining a total production of the oil and gas well and a productions of each of the production layers, and numbering each of the production layers in sequence;
a production calculation unit used for calculating a percentage of the production of each of the production layers to the total production, dividing the production layers into high-production layers, middle-production layers, and low-production layers based on the percentage of production of each of the production layers to the total production, calculating average productions of the high-production layers, middle-production layers, and low-production layers respectively;
an opening degree Calculation unit used for calculating an opening degree of orifices of each of the fluid control valves by dichotomy when productions of the production layers are balanced based on above calculation results.

18. A system for automatically adjusting an opening degree of a fluid control valve, comprising:
one or more fluid control valves, wherein each of the one or more fluid control valves has an orifice structure in oil and gas production;
a fluid control valve control module for controlling an opening degree of each of the fluid control valves;
wherein the fluid control valve control module includes one or more processors, a memory, and one or more application programs; the one or more application programs are stored in the memory and configured to be executed by the one or more processors, and the one or more application programs are configured to execute the method according to claim 1.
